(19) United States
(12) Patent Application Publication
(10) Pub. No.: US 2005/0132054 A1
(43) Pub. Date: Jun. 16, 2005

(54) Fine-grained authorization by traversing generational relationships

(75) Inventors: David Yu Chang, Austin, TX (US); Vishwanath Venkataramappa, Austin, TX (US); Leigh Allen Williamson, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/732,627

(22) Filed: Dec. 10, 2003

(51) Int. Cl. G06F 15/16

(52) U.S. Cl. 709/227

(57) ABSTRACT

Methods, systems, and media are disclosed for determining access rights to a resource managed by an application. One embodiment includes receiving a request by the application, wherein the request comprises an action a user seeks to perform on the resource, and locating, based on the request, the resource in both a containment relationship graph and in a structure having groupings of resources, wherein the groupings comprise a grouping having the resource. Further, the embodiment includes traversing a vertex of the containment relationship graph, wherein the vertex comprises a generational resource of the resource, and reading an authorization table associated with a grouping having the generational resource in the groupings. Further still, the embodiment includes determining whether to grant the access rights for performing the action on the resource.

### FIELD OF INVENTION

The invention generally relates to controlling access rights for resources managed by an application. More particularly, the invention relates to methods, systems, and media for resources grouped with similar authorization constraints or policies, and granting access rights to act on a particular resource if an authorization table associated with a generational resource of the resource assigns the user a role that permits the act.

### BACKGROUND

In a networked environment, users have access to resources on the network. Resources, for instance, include nodes (i.e., computer systems), servers, applications, and clusters (i.e., collection of application servers). In order to access these resources, the network uses a security process requiring a user to log onto the network with a user identifier and password. After network verification, the user has access to all the resources on the network.

Management of these resources, however, typically occurs through use of an application server system, such as WebSphere Application Server™, which is in communication with the network. Managing resources includes, for example, stopping and starting a server, tuning a server, reading a log file on a node, and so forth. Before managing resources, however, an application may also require a security process for a user to log into the application. The security process may be the same or similar to the user identifier and password required for logging onto the network. Now, after verification, the user has access to all the resources, which the user may manage in an unfettered manner.

Oftentimes, organizations wish to restrict generalized access to resources on the network to prevent security breaches, such as infiltration and corruption, as well as to ensure proper management, such as configuration, administration, operation, and monitoring of the resources. To restrict access, implementation of additional security processes is necessary. Implementing additional processes requires additional constraints placed on both the user and/or the resource. These additional constraints are collectively termed “fine-grained authorization,” as opposed to the “coarse-grained authorization,” or generalized authorization, described above in terms of verification of user identifier and password.

Prior solutions for restricting, i.e., controlling, access to resources include use of policy-based authorization (“PBA”) systems. PBA is a fine-grained authorization technique that assigns access control policies to a user or group of users for permitted actions on the resources, that is, “permissions.” The permissions may include a variety of actions, such as stopping, starting, reading a log, tuning, or other actions on a particular resource. In addition, each permission is associated with one or more authorized users, who may perform the action. For example, if a PBA grants only configuration of server 1, but not server 2, to user A, then user A may configure server 1, but not server 2; additionally, user A would not have access rights to administrator, monitor or operate either server 1 or server 2. In sum, a PBA is often a file or list comprising one or more users assigned to an action on a resource in the form of (user/group name, resource, action).

Role-based authorization (“RBA”) is another, fine-grained authorization solution for restricting, i.e., controlling, access to resources. RBA assigns users to roles, wherein a role is a collection of actions for performing on resources, or, in PBA terms, a role is a set of permissions. Stated still another way, a role is most easily imagined as a definition of a job at the lowest level of granularity used in the organization. The roles may include a starter of a server, a stopper of a server, a tuner of a server, a modifier of an application, an administrator, and so forth, wherein each role is indicative of a set of permissible actions that the user assigned to the role has on a particular resource. For example, if an RBA grants only a role of configurator to user A for configuring server 1, but not for configuring server 2, then user A may configure server 1, but not server 2; additionally, user A, as configurator, would not have administrator, monitor or operator roles for acting on either server 1 or server 2. Overall, in an RBA control system, the system administrator need only grant or revoke access rights to a role, and group different subjects under a role in order to control the RBA system. In sum, an RBA is a file or list comprising one or more users assigned to a role defining the permissible actions for a resource in the form of (user/group name, role, resource).

Although providing added security, the prior solutions fail to do so with optimized scalability for managing the resources. That is, every resource using conventional PBA or RBA systems require each resource to have its own roles or policies with the likely structure including individual files for each resource, wherein the files fail to consider similarities in management authority and/or resources subject to a user's management authority. An individual file structure for each resource can quickly become a scalability nightmare for organizations having thousands of users. For instance, if there are a thousand resources, and, for sake of simplicity, assuming one role or one policy for each resource, then there are a thousand roles or a thousand policies for a given user. As a result of the un-optimized security system, another failure of the prior solutions is borne out: a relatively, high storage requirement for storing the many roles or policies for each user.

A need, therefore, exists, for methods, devices, systems, and media to provide for fine-grained authorization of administrative resources that optimizes scalability that also results in reducing storage requirements for implementation of the security system.

### SUMMARY OF THE INVENTION

Embodiments of the invention generally provide methods, systems, and media for determining access rights to a resource managed by an application. In one embodiment, the method generally includes receiving a request by the application, wherein the request comprises an action a user seeks to perform on the resource, and locating, based on the request, the resource in both a containment relationship graph and in a structure having groupings of resources, wherein the groupings comprise a grouping having the resource. Further, the method includes traversing a vertex of the containment relationship graph, wherein the vertex comprises a generational resource of the resource, and reading an authorization table associated with a grouping having the generational resource in the groupings. Further still, the method includes determining whether to grant the access rights for performing the action on the resource.

In another embodiment, the invention provides a system for determining access rights to a resource managed by an application. The system includes an input module for receiving a request from a user for performing an action on a resource, and a locator module for locating the resource in a containment relationship graph and in a structure having groupings of resources, wherein the groupings comprise a grouping having the resource. Further, the system includes a traverser module for traversing a vertex of the containment relationship graph, wherein the vertex comprises a generational resource of the resource, and a reader module for reading the authorization table associated with the grouping having the generational resource. Further still, the system includes a decision module for determining whether to grant the access rights for performing the action on the resource.

In yet another embodiment, the invention provides a machine-accessible medium containing instructions for determining access rights to a resource managed by an application, which when executed by a machine, cause the machine to perform operations. The instructions generally include operations for receiving a request by the application, wherein the request comprises an action a user seeks to perform on the resource, and operations for locating, based on the request, the resource in a containment relationship graph and in a structure having groupings of resources, wherein the groupings comprise a grouping having the resource. Further, instructions include operations for traversing a vertex of the containment relationship graph, wherein the vertex comprises a generational resource of the resource, and operations for reading an authorization table associated with a grouping having the generational resource in the groupings. Further still, the instructions include operations for determining whether to grant the access rights for performing the action on the resource.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1A depicts a system for determining access rights to a resource managed by an application in accordance with the disclosed invention.

FIG. 1B depicts a containment relationship graph in accordance with the disclosed invention.

FIG. 2 depicts an authorization table in accordance with the disclosed invention.

FIG. 3 depicts an example embodiment of a system for determining access rights to a resource managed by an application in accordance with the disclosed invention.

FIG. 4 depicts an example embodiment of a method for determining access rights to a resource managed by an application in accordance with the disclosed invention.

FIG. 5 depicts an example embodiment of a system for determining access rights to a resource managed by an application in accordance with the disclosed invention

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods, and media for determining access rights to a resource managed by an application are contemplated. Embodiments include a networked environment, wherein a user has access, through, for example, verification of a user identifier and password, to an application for management of resources within a cell. Recognizing a cell as a collection, for whatever reason, of certain resources, then within the cell resides resources, which optionally include, for example, smaller cells, nodes (i.e., computer systems), servers, applications, and clusters, which are collections of application servers.

Verification of user identifier and password, however, merely provides coarse-grain authorization to the resources accessible through the application permitting management of the resources. Additional security constraints on a cell's resources, however, may restrict a user's actions to some or all of the resources in the cell. Implementation of such additional security or authorization requirements is called fine-grained authorization, which may result from using conventional role and/or policy-based access control techniques. Embodiments of the invention, however, have significantly modified these conventional techniques to create a new technique called authorization group, which when used with a traversed containment relationship graph, combine to determine whether to grant access rights to a user seeking to act on a resource. The authorization group arises by grouping resource instances having similar authorization constraints, and it is possible to explain the origins of the authorization group from either a policy based authorization (“PBA”) system approach or a rule-based authorization system approach. Before showing the theory behind creation of the authorization group, however, it is preferable to provide further discussion of the embodiments.

After a user accesses the application from, for example, a computer system or PDA, the user submits a request representing action to be performed on a resource. Granting access rights to the user for the requested action on the particular resource depends on whether the particular resource is in a grouping to which the user has access rights, and whether the user has access rights to perform the requested action. With the resources already grouped by similar authorization constraints, a task configured and re-configurable by a system administrator or the like, locating the particular resource in a group, and reading an authorization table attached to the grouping containing the resource determines whether to grant access rights to the user to perform the requested action on the particular resource. Presuming, however, that the authorization table denies a user access rights to perform the act on the resource containing the group, access rights may still arise by traversing a containment relationship graph for generational resources of the resource, and determining whether to grant access rights to perform the act on the resource by determining the access rights accorded to the generational resource by the authorization table associated with the generational resource.

With this overview, it is helpful to discuss some general concepts behind the disclosed, fine-grained, authorization methods, systems, and media before continuing on to the theory behind the creation of the authorization table. Every resource has a “type” attribute. That is, for example, a resource can be a server type or application type. In addition, there may be multiple “instances” of resources of the same type, such as, multiple servers or multiple applications. All types and instances of resources in a cell, however, often do not require different authorization constraints, and, as a result, such similarly constrained types and instances of resources may be grouped together with the same authorization constraints. Such a grouping of resources within a cell is called an “authorization group” or a “resource group,” collectively called “groups.” After forming these groups, it is already apparent that assigning users to these groups improves scalability and storage requirements, as compared to prior solutions, which assign resource instances to individual users (i.e., a file for each individual) or without grouping as to similar constraints.

Turning now to explaining the theory behind the authorization table, from the RBA perspective, a typical role involves mapping users to roles and mapping roles to permissions. A user/group is a person or persons, and a role is a collection of permissions, wherein a permission is a resource and an action, such as stopping or starting a resource. The user mapping to roles may be represented by an “authorization table,” whether or not the authorization table actually comprises a table, or is represented by file(s), list(s), or so on. Instead of the conventional mapping of roles to permissions, however, a new approach is disclosed that maps roles to one of a discrete number of actions, wherein the roles subsume the actions. In an example embodiment, administration of the permitted actions on all resources can be broadly defined by four classes labeled administrative action, configuration action, operational action, and monitor action, wherein the roles adopt the names of the permitted actions, i.e., administrator, configurator, operator, and monitor, respectively. As a result, embodiments result in a mapping of authorization table to resource group, wherein resource group, as above-defined, are similarly constrained types and instances of resources already configured into groups.

From the PBA perspective, a typical policy reads (user/group, resource group, action), wherein user/group is a person or persons, resource group is above-defined, and action is an operation, such as stopping or starting a server, to be performed on a particular resource. Again, in embodiments of the invention, all possible actions on resources in a resource group are definable in terms of four classes labeled administrative action, configuration action, operational action, and monitor action. Re-writing the typical policy in these defined classes yields (user/group, resource group, {administrative action, configuration action, operational action, and monitor action}). Again, re-writing these actions in terms of the four roles yields (user/group, resource group, {administrator, configurator, operator, and monitor}). Final reduction from the PBA perspective yields the same result as from the RBA perspective, that is, a mapping of authorization table to resource group. Therefore, the authorization table may be explained from either a PBA or an RBA perspective. As a final matter, it is understood that variance in terms of the number of defined roles on the resource, the specific actions permitted by the roles, and the uses beyond administrative management of resources on computers systems, such as on PDAs, are contemplated and within the scope of the invention, although further examples are not explicitly discussed herein.

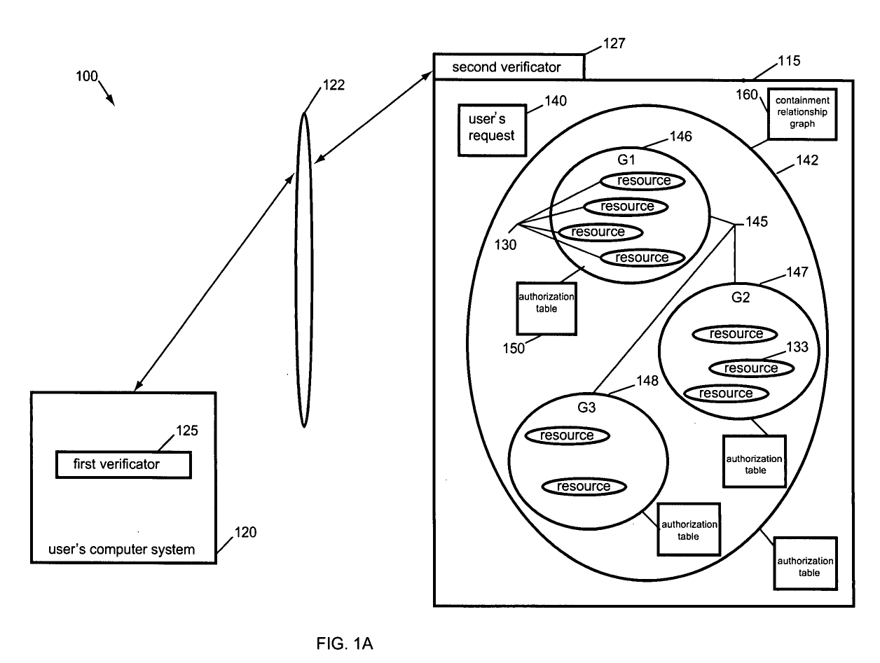

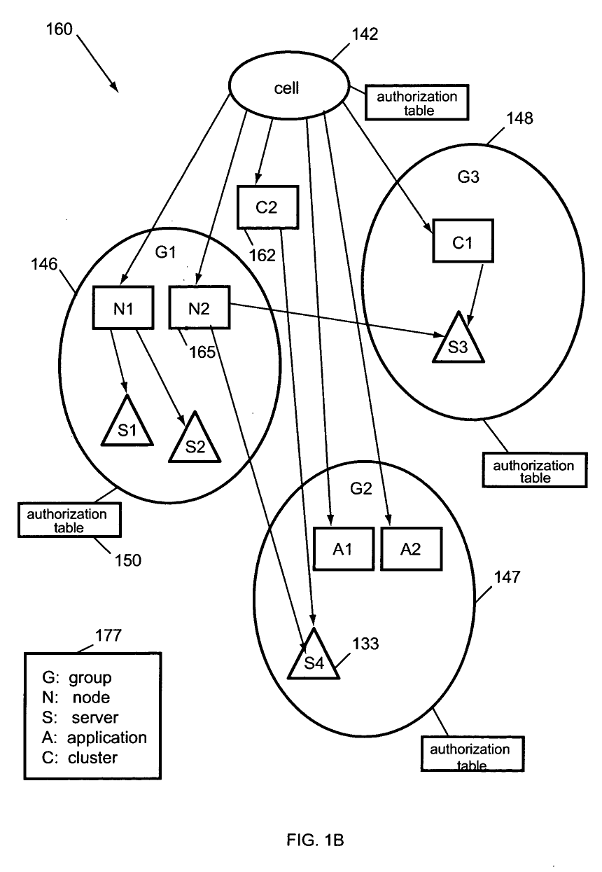

Turning now to the drawings, FIG. 1A depicts an embodiment of a system 100 for determining whether to grant or deny access rights to a resource 130 managed by an application 115. FIG. 1A depicts a user's computer system 120 in communication through a network connection 122 to an application 115 associated with a non-depicted, remote computer system. The remote computer system may be either a stand-alone computer system or part of a network of computer systems that is either on the same or different network than the user's computer system 120.

Before accessing application 115 associated with the remote computer system, the system 100 depicts a first verificator 125 on the user's computer system 120 and an optional, second verificator 127 associated with the application 115. The first verificator 125 requires the user to enter identifying information, such as a user identifier and a password, which is verified by logic associated with the user's computer system 120 to determine whether to grant access to the user's computer system 120. The optional, second verificator 127 functions in much the same way as the first verificator 125. That is, the second verificator 127 requires the user to enter identifying information, which may be the same or different from the identifying information used for accessing the user's computer system 120, and after verification by logic associated with the second verificator 127, the user has access to the application 115.

Once access to the application 115 exists, the system's 100 application 115 receives a user's request 140 for an action on a resource, say, resource 133, for example. Before discussing the request 140, it is worthwhile to understand the purpose behind the application 115. The application 115, whether local or remote to the user's computer system 120, is used for managing an organization's resources 130, such as nodes (i.e., computer systems), servers, applications, and clusters (i.e., collection of application servers). The application 115, for example, is an application management server system, such as IBM™ WebSphere Application Server™ or Vitria™ BusinessWare™, and/or may include application management systems available through Web Services, which have defined core protocols, query language, interfaces, and specifications, all of which provide for easy integration into the system 100 for enterprise management solutions.

Managing an organization's resources 130, in an administrative manner, for example, entails many actions that a user may seek to perform on the resources 130. After logging on to the user's computer system 120, which may be, for example, part of an organization's computer system or a PDA, a user may enter a request 140 to perform an action on a resource 133, wherein resource 133 is enumerated in FIG. 1A for clarity of this discussion. Logic associated with the user's computer system 120 and/or the application 115 may prompt the user to enter the request 140, which is then processed by the application 115 to identify the requested action that the user wishes to perform on the requested resource, such as resource 133. For example, the request 140 may state, “tune server 17.” Upon receipt of the request 140 by the application 115, logic, enabled by software and/or hardware, interprets the request 140 and understands that the request 140 means that the user wishes to perform the action of “tuning” on the resource already bearing the identity of “server 17.”

The system 100 includes locating the requested resource, again, say resource 133, for beginning to determine whether the user has access rights. As a pre-condition to implementing the system 100, however, a system administrator or otherwise empowered authority has grouped the system's 100 resources into groupings 145 of resources 130 having similar authorization constraints within a cell 142, which encompasses all of the organization's resources 130; these groupings 145 are also re-configurable if the organization desires or needs to change the constraint for whatever reason. For instance, FIG. 1A depicts three groupings 145, namely G1 146, G2 147, and G3 148, wherein each of the groupings 145 contain similarly constrained resources 130 within their respective groupings 145. The groupings 145, themselves, for example, are lists or xml files arranged in a structure, and logic associated with the application 115 searches the files in the structure to locate the group containing the requested resource, such as resource 133, among the groupings 145. By example, FIG. 1A shows G2 147 to contain the resource 133.

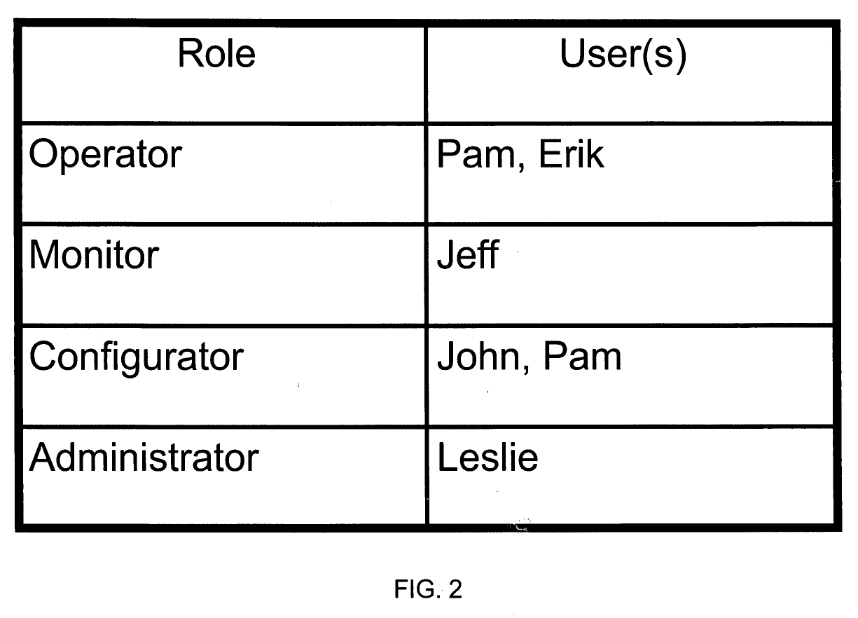

After locating the group containing the requested resource, the system 100 includes reading an authorization table 150 associated with the group having the requested resource on which the user seeks to perform an action; in FIG. 1A, by example only, the requested action is sought to be performed on resource 133 within G2 147. Each of the groupings 145 has an associated authorization table 150 that maps roles to users, wherein FIG. 2 depicts an example authorization table, which is labeled 150 in FIG. 1A. For the resources in any particular group, the roles are permitted actions on the resources in that group. With the system 100 used for administration of resources, the roles, for example, may be limited to four broadly defined classes, including administrator, operator, configurator, and monitor, wherein the roles' namesakes also broadly represent the permitted actions, that is, administrating, operating, configuring, and monitoring, respectively. Variance of the system 100 in terms of the number of defined roles on the resource, the specific actions permitted by the roles, and the uses of the system 100 beyond administrative management of resources are contemplated and within the scope of the invention, although further examples are not explicitly discussed herein.

Returning to the example embodiment of administrative management of the resources, explanation of the actions associated with the four roles include: an administrator having all actions over the resources in a group; an operator having start and start actions, for example, over resources in a group; a configurator having tuning actions, for example, associated with the resources in a group; and a monitor having reading and displaying actions, for example, over resources in a group. With this understanding of the example actions incorporated into the roles, then determination whether to grant access rights to a resource, say, resource 133, is accomplished by logic, enabled software and/or hardware, for locating the resource in a containment relationship graph 160, and then traversing the containment relationship graph 160 in communication with the groupings 145 of resources.

Turning now to FIG. 1B, the containment relationship graph 160 is depicted by pictorial representation, although in the system 100, the containment relationship graph 160 may be, for example, table(s), list(s), xml files, and so on. The system 100 includes logic, enabled by code available at run time or reduced to one or more processors, for traversing a vertex 162 of a resource, for example, resource 133, in a containment relationship graph 160, wherein a vertex 162 comprises a generational resource of the resource. Before traversing the containment relationship graph 160, however, logic, again enabled by software and/or hardware, locates the generational resource(s) of a resource, for example, locating generational resource 165, on different generational branch than vertex 162, but resource 165 is equally a generational resource of resource 133; notably, resource 133 is also a generational resource, albeit the zero generation of the resource. Continuing with this example, generational resource 165 comprises a node and resource 133 comprises a server, as denoted by the legend 177 on FIG. 1B. Further up the generational resource 165 and resource 133 chain is cell 142, which is also a generational resource, albeit the grandparent, of resource 133. As discussed in this disclosure, each of the generational resources is a distinct vertex within the containment relationship graph 160 in relation to the particular resource at issue. So, by the example depicted in FIG. I B, generational resource 165 and cell 142 are distinct vertices of resource 133 in the containment relationship graph 160.

After locating a generational resource of a resource on which a user seeks to perform an action, the system 100 further includes logic, enabled by software and/or hardware, for traversing a vertex. Although the logic may permit traversing all the generational resources simultaneously, typically, the logic enables traversing the vertex closest, that is, most related, to a resource before traversing any vertices further removed from the resource. In addition, the traversing is generally performed in successive generation order, that is, traversing a parent resource before a grandparent resource, a grandparent resource before a great-grandparent resource, and so on. By example, and with reference to FIG. 1B, for resource 133, the system 100 first traverses the vertex representative of generational resource 133 in the containment relationship graph 160 before traversing generational resource 133, and then vertices further removed from the resource, such as cell 142, the grandparent resource, which, in FIG. 1B, is also the root resource, that is, the most removed, generational resource to resource 133.

After traversing the containment relationship graph 160 for a generational resource of a resource, the system 100 further includes logic for reading the generational resource's authorization table 150, which, like the containment relationship graph 160, may take the form, for example, of list(s) and/or file(s), such as xml files, to render possible a determination whether to grant or deny access rights to the requested action on the requested resource. Notably, the generational resource may or may not be within the same grouping as the resource. For example, by reference to FIG. 1B, generational resource 165 is not within the same grouping as resource 133; that is, generational resource 165 is within G1 146, and resource 133 is within G2 147. As a result, in this example, the system's 100 logic for reading the authorization table 150 reads the authorization table associated with G1 146, not G2 147, in order for later determining whether to grant access rights to perform the requested action on resource 133 within G2 147.

To determine whether to grant access rights to the user making the request 140, logic associated with the application 115 grants access rights if the generational resource group's authorization table 150 indicates that the user has the assigned role necessary for performing the action in the user's request 140. For example, if the authorization table 150 associated with generational resource 165 indicates that user A has the role of an operator for resources in G1 146, then user A may start or stop a resource 133, a server located in G1 146. Practically, this makes sense because if user A may operate on generational resource 165, here, a node, then user A should also be able to operate on resource 133, a resource contained by generational resource 165. That is, the system's 100 logic understands and makes use of the hierarchical structure of an organization's resources in order to streamline resource management. On the other hand, the same logic associated with the application 115 denies access rights if the generational resource group's authorization table 150 indicates that the user does not have the assigned role necessary for performing the action in the user's request 140. Again, by example, if the authorization table 150 associated with generational resource 165 indicates that user A only has the role of a configurator for resources in the generational resource's group, here, G1 146, then user A's request 140 to start or stop a resource 133 in G2 is denied because such actions are defined by the role of an operator for resources within G1 146 or contained by a resource within G1 146.

Before finally denying access rights to perform the requested action on the requested resource, and communicating the same to the user over the network from the application to the user's computer system 122, the system 100 further includes logic for iterating the traversing, the reading, and the determining for each vertex, up through the root resource, in the containment relationship graph 160. If the authorization table 150 associated with a grandparent, great-grandparent, etc. resource, as determined by traversing vertices of the containment relationship graph 160, grants the multi-generationally removed generational resource a role subsuming the requested action on the requested resource, then the system 100 grants the requested action on the requested resource. Otherwise, the system 100 denies access rights to perform the requested action on the requested resource, and optionally communicates the denial to the user over a network communication 122 to the user's computer system 120.

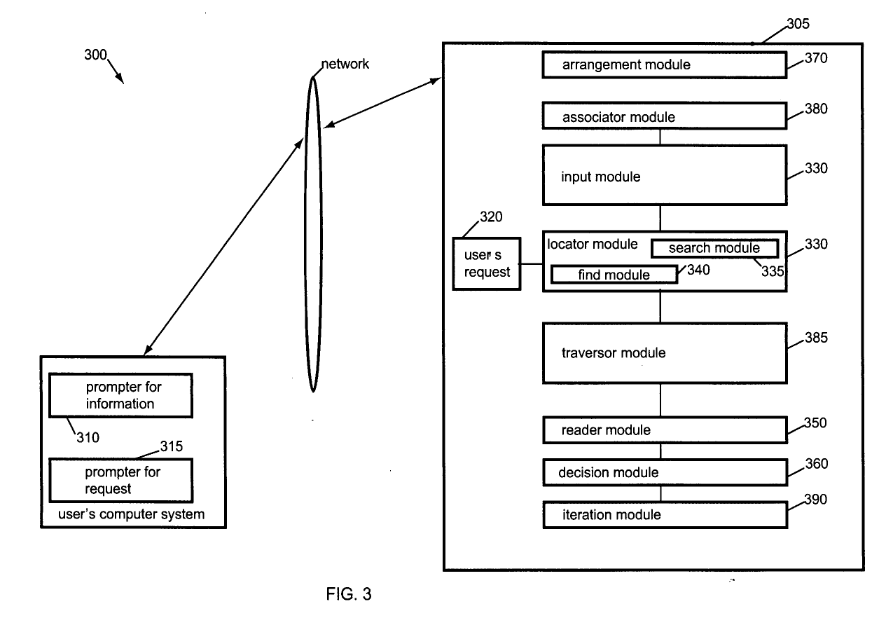

Turning now to FIG. 3, an example embodiment of another system 300 for determining access rights to a resource managed by an application 305 is disclosed. System 300 includes an application 305, wherein the application 305, for example, may be an application management server system such as WebSphere Application Server™, Web Services providing application management services, or a local application running on an organization's own networked, computer systems.

After a user logs onto a computer system 301 in communication, likely via a network 302, with the system 300's application 305, the system 300 optionally includes a prompter 310 for prompting the user at the user's computer system to enter security information to access the application 305. Such security information includes, for example, a user identifier and password verified by logic associated with the application 305. After successful logon to the application 305, the system 300 further includes another prompter 315 for prompting the user to enter a request 320 for performance of requested action on a particular resource managed by the application. The user then sends the request 320 to the application 305 for receipt and interpretation.

The system 300 includes an input module 325 for receiving the request 320. The input module 325, enabled by software code available at run time and/or hardware, such as a code reduced to a processor (collectively, “logic”), receives the user's request 320. The input module's 325 logic interprets and identifies the user, requested action and the particular resource on which the requested action is sought.

The system 300 also includes a locator module 330. After identification of the requested resource and requested action, the locator module 330 of the system 300 receives the identified request by logic either requesting the identified request from the input module 325 or the input module 325 sending the identified information to the locator module 330. The locator module 330, enabled by logic in associated software and/or hardware, includes component modules, namely a search module 335 and a find module 340, which may or may not be separate modules.

Before discussing the locator module 330, it is helpful to understand the organization of the resources implementing the system 300. A system administrator or otherwise empowered authority uses a further aspect of the system 300, namely an arrangement module 370. The arrangement module 370, enabled by logic in software and/or hardware associated with the system 300, permits arranging of the system's 300 resources into groupings of resources having similar authorization constraints within a cell, which encompasses all of the organization's resources; these groupings are re-configurable if the organization desires or needs to change the constraints for whatever reason. The groupings contain similarly constrained resources, and are arranged in a structure of lists or files, such as xml files.

A secondary structure of the resources arises through a containment relationship graph, such as the visual depiction shown in FIG. 1B. In the system 300, the containment relationship graph may take the form of lists or files, such as xml files. The containment relationship graph, itself, charts the generational resources that contain the requested resource upon which the user seeks to perform the requested action. To do so, the containment relationship graph makes use of the hierarchical relationship existing between resources. That is, for example, a resource, such as a server, may be contained by a node, which may be contained by a cell. Another containment relationship example is a cell containing a cluster containing several servers, wherein any or all of the contained resources may or may not be in the same grouping of resources as the generational resource containing the child resource.

Returning now to the search module 335, enabled by software and/or hardware logic, the search module 335 searches the structure of groupings, and the find module 340, similarly enabled by logic, finds the resource in the grouping having the identified resource of the request. The found resource is then passed to the traversor module 385 by logic associated with the application 305. The logic associated with the traverser module 385 traverses the containment relationship graph, depicted in FIG. 1B, to a vertex, wherein the vertex comprises a generational resource and/or generational resources of the found resource. In order to traverse the containment relationship, logic, either separate logic or logic for invoking the logic within the locator module 330, searches and finds the generational resource(s) of a resource. Typically, the traverser module's 385 logic first finds the generational resource closest, that is, most related to the requested resource before the system 300 locates generational resources further removed, such as a grandparent or great-grandparent resource, from the requested resource. However, the traversor module 385 may find all the generational resources in the chain of generational resources culminating in the root resource.

The system 300 further includes a reader module 350 for reading the found generational resource(s), based on the request, wherein the found generational resource is passed from the traversing module 385 to the reader module 350 by logic associated with the traversor module 385 and/or the reader module 350. Before further discussing the reader module 350, it is necessary to understand a further aspect of the system 300, the associator module 380. The assoicator module 380, enabled by logic in software and/or hardware associated with the system 300, allows for associating each group of resources with its own, individualized authorization table, which maps roles to users.

For the resources in the particular group, the roles are permitted actions on the resources in that group. With the system 300 used for administration of resources, the roles, for example, may be limited to four broadly defined classes, including administrator, operator, configurator, and monitor, wherein the roles' namesakes also broadly represent the permitted actions, that is, administrating, operating, configuring, and monitoring, respectively. Variance of the system 300 in terms of the number of defined roles on the resource, the specific actions permitted by the roles, and the uses of the system 300 beyond administrative management of resources are contemplated and within the scope of the invention, although further examples are not explicitly discussed herein.

The reader module 350, enabled, for example, by coded logic or logic reduced to a processor, reads the authorization table associated with the group having the found generational resource of the request. By the reader module 350 reading the authorization table, the reader module identifies the permitted roles for users on resources both within the found generational resource's group and contained by the found generational resource.

The system 300 also includes a decision module 360 for determining whether to grant the access rights for performing the action on the resource. The decision module 360, enabled by software and/or hardware logic, receives the information from the input module 325, locator module 330, and/or reader module 350 for determining whether to grant access rights to the user for the request 320. In particular, the decision module 360 receives the identity of the user, the identity of the found resource, the identify of the found generational resource from the traversor module 385, and the user's assigned role based on the found generational resource's group authorization table. Through still more logic associated with the decision module 360, the decision module 360 grants the requested action on the found resource if the requested action on the found generational resource, which contains the found resource, is permitted by the user's assigned role. If the decision module 360 denies the requested action on the found resource, then the system 300 may communicate the denial over a network communication to the user's computer system.

Before finally denying access rights to perform the requested action on the requested resource, and optionally communicating the denial to the user over the network from the application to the user's computer system, the system 300 further includes an iteration module 390. Logic, through code in software or reduced to one or more processor(s), associated with the iteration module 390 re-invokes the traversor module 385 to find a vertex further removed from the resource than the generational resource previously resulting in a denial of access rights to perform the requested action on the found resource. The re-invoking by the iteration module 390 further re-invokes the reader module 350 and the decision module 360, in the same way as previously described, except that this time, the decision of whether to grant or deny access rights is based on a vertex in the containment relationship that is for a generational resource other than the generational resource previously resulting in denial of access rights. The logic in the iteration module 390, similar in principle to logic in the traversor module 385, typically re-invokes traversal of the containment relationship graph by successive generation order beginning with the generational resource closest to last generational resource resulting in denial of access rights to perform the action on the resource. The iteration module 390 continues the re-invoking of the traversor module 385, and consequential re-invoking of the reader module 350 and the decision module 360, through the chain of generational resources until a generational resource's authorization table grants the user access rights to perform the action on the resource, or the decision based on traversing the root resource, that is, the ultimate generational resource, results in a denial of access rights to perform the action on the resource.

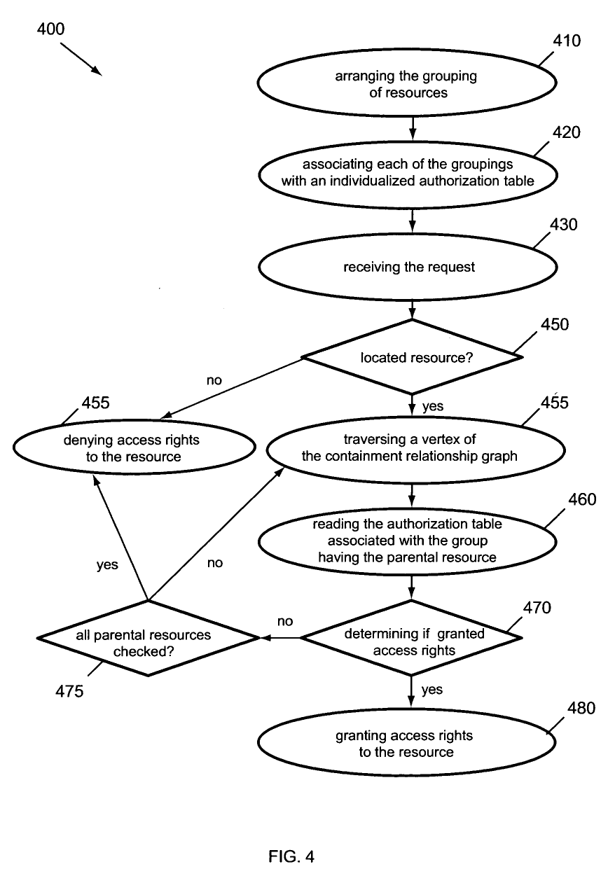

Turning now to FIG. 4, another aspect of the invention is disclosed. In particular, an embodiment of a flowchart 400 for determining access rights to resource managed by an application is disclosed. Flowchart 400 is for a system, such as systems 100 and 300, as shown in FIG. 1A, FIG. 1B and FIG. 3.

Flowchart 400 begins by arranging 410 an organization's resources managed by an application such as an application management server system. The resources, themselves, are typically nodes, clusters, applications and servers, just to name a few, which the application manages, for example, in an administrative manner, through a configured arrangement of the resources. The arranging 410, enabled by logic in software and/or hardware associated with the application or the user's computer system, occurs by a system administrator or other empowered authority arranging the resources into groupings having similar authorization constraints. That is, such groupings have resources that are isolated from an organization's other resources, whether those other resources are in other groups or smaller cells within the organization's overall cell of resources. Further, the resources in a particular group are grouped because it is likely, for whatever reason, that the users of the resources in a particular group need access to perform some or many actions on some or all of the resources in the group; equally, however, resources in other groups are in other groups because the just referenced users may not need to or are restricted from performing actions on resources in other groups. Hence, grouping of resources by similar authorization constraints provides security by mitigating the potential access rights to an organization's resources.

After arranging 410 the groupings of resources, the flowchart 400 continues by associating 420 each one of the groupings with its own authorization table. To particularize the authorization constraints on the similarly constrained resources within a grouping, software and/or hardware associated with the application or the user's computer system enables the associating 420 of an attachment table to a grouping. The attachment table is a mapping of roles to users, and, thereby, spells out what actions, here, in terms of roles, that every user may perform on the resources in the group. In an administrative management implementation, for example, the permitted actions may be defined in terms of four broadly classified roles, namely administrator, configurator, operator, and monitor. The arranging 420, therefore, fine tunes the associating 420, all of which occurs by an authority, whether a person or automated, generating lists or files, such as xml files, representative of the groupings and authorization tables.

Progressing further down the flowchart 400, the application receives 430 a request to perform an action on a particular resource. The request is likely generated and sent from a user's computer system or PDA, for example, in network communication with the application managing the organization's resources. For receiving 430 the request, the user may directly enter the request into the application or the user may be prompted, perhaps at the user's computer system, to enter a request. Before receiving 430 the request, however, the flowchart 400 may prompt a user seeking access to the application to enter security information. Upon verification, the user is granted access to the application. This added security measure ensures that only authorized users may attempt to perform an action on a resource managed by the application.

After receiving 430 the request, software and/or hardware logic associated with the application interprets the request to identify the relevant, constituent parts of the request. That is, the user, the requested action on a resource, and the requested resource on which the requested action is desired. Based on this interpreted information in the request, the flowchart 400 continues by locating 450, through software and/or hardware logic associated with the application, the requested resource by searching the groupings. Locating 450 in the flowchart 400 is depicted as a decision block because if the requested resource is not found upon searching the groupings, then the flowchart 400 returns with denying 455 of access rights to the requested resource. Such a denial of access rights may be communicated to the user by sending a message indicating denial of access rights, and, optionally, include a reason such as “file not found” or “resource does not exist.” Upon finding the requested resource, however, in the grouping containing the requested resource, the flowchart 400 continues.

Moving down the flowchart 400, the flowchart 400 continues after locating 450 the found, requested resource by traversing 455 a vertex of a containment relationship graph, wherein the vertex is a generational resource of the resource. For traversing 455 a vertex in the containment relationship, logic, either separate logic or logic for invoking the logic within the locator module 330, searches and finds the generational resource(s) of a resource. Typically, logic enabling the traversing 455 a vertex according to the flowchart 400 first finds the generational resource closest, that is, most related to the requested resource before the flowchart 300 locates generational resources further removed, such as a grandparent or great-grandparent resource, from the requested resource. However, traversing 455 a vertex in the flowchart may locate all the generational resources in the chain of generational resources culminating in the root resource, and then evaluate each traversed vertex down the flowchart 400, wherein the order of evaluation down the flowchart typically starts with the resource, itself, then the parent resource, and then the grandparent resource, and so on.

The flowchart 400 further includes logic for enabling a system embodying the disclosed method for reading 460 an authorization table associated with the grouping containing the found, generational resource. Through software and/or hardware logic associated with the application, reading 460 the authorization table entails reading the roles assigned to the users for the actions on the resources in the group containing the found, generational resource and for resources constrained by the found, generational resource.

The flowchart 400 continues with a determination decision block 470 indicative of the determining whether to grant or deny access rights for the action on the request in the user's request. Again, enabled by software and/or hardware logic associated with the application, distillation of access rights to perform the request based on evaluating the now known quantities of user identity and the permissive actions, i.e., roles, on the found, generational resource in the grouping constraining the requested resource. If the known quantities align to indicate that the user has the role to perform the requested action on the requested resource, that is, the group's authorization table for the found, generational resource indicates that the requested action is subsumed by a role granted to the generational resource, then the application's logic grants 480 access rights to the user to perform the requested action on the resource.

However, if the generational resource group's authorization table does not grant access rights to the user to perform the action on the resource constrained by the traversed vertex, that is, the particular generational resource evaluated, then the flowchart continues with a decision block 475 querying whether further, untraversed generational resources exist in the resource's chain of generational resources as charted by the containment relationship graph. For example, if the flowchart 400 has only traversed a first vertex, likely the parent, then the flowchart continues by re-invoking the traversing of a different vertex in the chain of generational resources constraining the resource, as determined by the containment relationship. An iterative loop of traversing vertices, reading the authorization table associated with the traversed vertices, and determining if access rights are granted continues until access rights to perform the action on the requested resource is granted or after traversing all generational resources results, with the last traversed generational resource likely being the root resource (i.e., the generational resource farthest removed from the resource in a chain of generational resources), in denying the user access rights to perform the requested action on the requested resource.

At this point, having discussed systems and methods, it is useful to discuss the achieved advantages. In particular, as compared to prior solutions, scalability is markedly increased by the grouping of similarly constrained resources and the attachment table. For example, instead of having individual files for access rights to resource 1, resource 2, resource 3 and resource 4, and assuming these four resources are used by fifty users, then grouping these similarly constrained resources into one group with an associated authorization table indicating the permitted actions on the resources by the fifty users results in the writing of two files, one for the group and one for the authorization table, instead of the perhaps fifty files necessary by the prior solutions. Further, recognizing a secondary structure within the groupings, i.e., a containment relationship graph, further reduces the number of necessary files for articulating access rights to user of an organization's resources. In addition to the reduced amount of logic, having two files instead of fifty files also significantly reduces the amount of storage necessary for access rights for managing the resources, as well as possibly decreasing the amount of processing time to determine whether access rights exist.

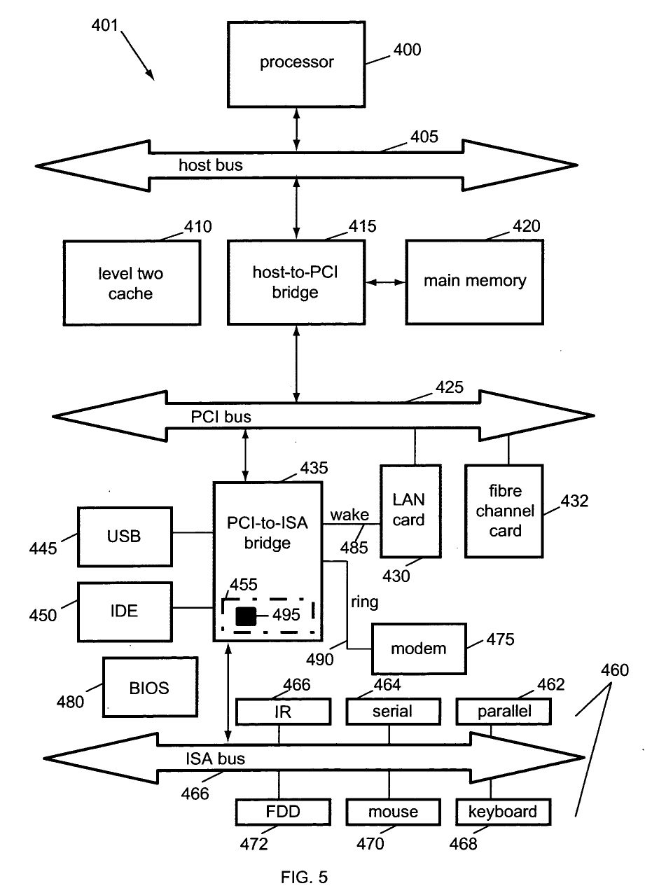

FIG. 5 illustrates information handling system 501 which is a simplified example of a computer system capable of performing the operations described herein. Computer system 501 includes processor 500 which is coupled to host bus 505. A level two (L2) cache memory 510 is also coupled to the host bus 505. Host-to-PCI bridge 515 is coupled to main memory 520, includes cache memory and main memory control functions, and provides bus control to handle transfers among PCI bus 525, processor 500, L2 cache 510, main memory 520, and host bus 505. PCI bus 525 provides an interface for a variety of devices including, for example, LAN card 530. PCI-to-ISA bridge 535 provides bus control to handle transfers between PCI bus 525 and ISA bus 540, universal serial bus (USB) functionality 545, IDE device functionality 550, power management functionality 555, and can include other functional elements not shown, such as a real-time clock (RTC), DMA control, interrupt support, and system management bus support. Peripheral devices and input/output (I/O) devices can be attached to various interfaces 560 (e.g., parallel interface 562, serial interface 564, infrared (IR) interface 566, keyboard interface 568, mouse interface 570, fixed disk (HDD) 572, removable storage device 574) coupled to ISA bus 540. Alternatively, many I/O devices can be accommodated by a super I/O controller (not shown) attached to ISA bus 540.

BIOS 580 is coupled to ISA bus 540, and incorporates the necessary processor executable code for a variety of low-level system functions and system boot functions. BIOS 580 can be stored in any computer readable medium, including magnetic storage media, optical storage media, flash memory, random access memory, read only memory, and communications media conveying signals encoding the instructions (e.g., signals from a network). In order to attach computer system 501 to another computer system to copy files over a network, LAN card 530 is coupled to PCI bus 525 and to PCI-to-ISA bridge 535. Similarly, to connect computer system 501 to an ISP to connect to the Internet using a telephone line connection, modem 575 is connected to serial port 564 and PCI-to-ISA Bridge 535.

While the computer system described in FIG. 5 is capable of executing the invention described herein, this computer system is simply one example of a computer system. Those skilled in the art will appreciate that many other computer system designs are capable of performing the invention described herein.

Another embodiment of the invention is implemented as a program product for use with a computer system such as, for example, the system 100 shown in FIGS. 1A and 1B, and the system 300 shown in FIG. 3. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

While the foregoing is directed to example embodiments of the disclosed invention, other and further embodiments of the invention may be devised without departing from the basic scope thereof, and the scope thereof is determined by the claims that follow.

1. A method for determining access rights to a resource managed by an application, the method comprising:
receiving a request by the application, wherein the request comprises an action a user seeks to perform on the resource;
locating, based on the request, the resource in a containment relationship graph and in a structure having groupings of resources;
traversing a vertex of the containment relationship graph, wherein the vertex comprises a generational resource of the resource;
reading an authorization table associated with a grouping having the generational resource in the groupings; and
determining whether to grant the access rights for performing the action on the resource.

2. The method of claim 1, further comprising prompting the user for the request before the receiving a request.

3. The method of claim 1, further comprising, prior to the receiving, arranging the groupings by similar authorization constraints for the resources, and associating each of the groupings with the authorization table tailored for each of the groupings.

4. The method of claim 1, further comprising iterating the traversing, the reading, and the determining of the vertex through a root resource before denying the access rights for performing the action on the resource.

5. The method of claim 1, wherein the locating comprises searching the containment relationship graph and finding the resource relationships for the resource, and searching the structure and finding within the structure the grouping having the resource.

6. The method of claim 1, wherein the groupings, the attachment table, and the containment relationship graph comprise xml files.

7. The method of claim 1, wherein the traversing comprises traversing the generational resource by successive generations in relatedness order, whereby, the resource is traversed before a parent resource is traversed, and the parent resource is traversed before a grandparent resource is traversed.

8. The method of claim 1, wherein the reading comprises reading a mapping of roles to users, wherein the roles comprise a collection of actions permitted by the user on the generational resource.

9. The method of claim 8, wherein the action of the request is defined by one of the roles.

10. The method of claim 1, wherein the determining whether to grant access rights for performing the action on the resource to a user comprises granting access if the authorization table associated with the grouping having the generational resource indicates the user has permission to perform the action.

11. A system for determining access rights to a resource managed by an application, the system comprising:
an input module for receiving a request from a user for performing an action on a resource;
a locator module for locating the resource in a containment relationship graph and in a structure having groupings of resources;
a traversor module for traversing a vertex of the containment relationship graph, wherein the vertex comprises a generational resource of the resource;
a reader module for reading the authorization table associated with the grouping having the generational resource; and
a decision module for determining whether to grant the access rights for performing the action on the resource.

12. The system of claim 11, further comprising a prompter for entering the request into the input module.

13. The system of claim 11, further comprising an arrangement module for arranging the groupings of resources by similar authorization constraints, and an associator module for associating each of the groupings with the authorization table tailored for each of the groupings.

14. The system of claim 11, further comprising an iteration module for re-invoking the traversor module, the reading module, and the decision module through the vertex of a root resource before denying the access rights for performing the action on the resource.

15. The system of claim 11, wherein the locator module comprises a search module for searching the structure and for searching the containment relationship graph, and a find module for finding, in the structure, the grouping having the resource and for finding resource relationships of the resource in the containment relationship graph.

16. The system of claim 11, wherein the traversor module comprises a vertex locator module for invoking the locator module for locating the generational resource.

17. The system of claim 11, wherein the traversor module comprises traversing the generational resource by successive generations in relatedness order, whereby, a parent resource is traversed before a grandparent resource is traversed.

18. The system of claim 11, wherein the reader module comprises reading a mapping of roles to users, wherein the roles comprise a collection of actions permitted by the user on the generational resource.

19. The system of claim 18, wherein the action of the request is defined by one of the roles.

20. The system of claim 11, wherein the decision module for determining whether to grant access rights for performing the action on the resource to a user comprises granting access if the authorization table associated with the grouping having the generational resource indicates the user has permission to perform the action.

21. A machine-accessible medium containing instructions, which when executed by a machine, cause the machine to perform operations for determining access rights to a resource managed by an application, comprising:
receiving a request by the application, wherein the request comprises an action a user seeks to perform on the resource;
locating, based on the request, the resource in a containment relationship graph and in a structure having groupings of resources;
traversing a vertex of the containment relationship graph, wherein the vertex comprises a generational resource of the resource;
reading an authorization table associated with a grouping having the generational resource in the groupings; and
determining whether to grant the access rights for performing the action on the resource.

22. The machine-accessible medium of claim 20, wherein the instructions further comprise operations for prompting a user for the request before the receiving a request.

23. The machine-accessible medium of claim 20, wherein the instructions further comprise, prior to the instructions for performing operations for receiving, instructions for arranging the groupings by similar authorization constraints for the resources, and instructions for associating each of the groupings with the authorization table tailored for each of the groupings.

24. The machine-accessible medium of claim 20, wherein the instructions further comprise operations for iterating the traversing, the reading, and the determining of the vertex through a root resource before denying the access rights for performing the action on the resource.

25. The machine-accessible medium of claim 20, wherein the instructions for locating comprise instructions for searching the containment relationship graph and instructions finding the resource relationships for the resource, and instructions for searching the structure and instructions for finding within the structure the grouping having the resource.

26. The machine-accessible medium of claim 20, wherein the groupings, the attachment table, and the containment relationship comprise xml files.

27. The machine-accessible medium of claim 20, wherein the instructions for traversing comprise instructions for traversing the generational resource by successive generations in relatedness order, whereby, a parent resource is traversed before a grandparent resource is traversed.

28. The machine-accessible medium of claim 20, wherein the instructions for reading comprise instructions for reading a mapping of roles to users, wherein the roles comprise a collection of actions permitted by the user on the generational resource.

29. The machine-accessible medium of claim 28, wherein the action of the request is defined by one of the roles.

30. The machine-accessible medium of claim 20, wherein the instructions for determining whether to grant access rights for performing the action on the resource to a user comprise instructions to perform granting access if the authorization table associated with the grouping having the generational resource indicates the user has permission to perform the action.
